(19) United States
(12) Patent Application Publication
(10) Pub. No.: US 2010/0082476 A1
(43) Pub. Date: Apr. 1, 2010

(54) COMPREHENSIVE METHOD FOR INCREASING CREDIT SCORES

(76) Inventor: Eric A. Bowman, Cordova, TN (US)

Correspondence Address: ROY E. WILLIAMS, 1025 CROSSWINDS COVE, COLLIERVILLE, TN, 38017, US

(21) Appl. No.: 12/243,924

(22) Filed: Oct. 1, 2008

(51) Int. Cl. G06Q 40/00; G06Q 20/00

(52) U.S. Cl. 705/38; 705/35; 705/40

(57) ABSTRACT

A comprehensive method for guaranteeing an increase in the credit score of a qualified consumer, which subsequently assists the consumer in securing all types of loan financing, including, but not limited to, mortgage financing, business financing, and general loan financing (e.g., automobile, motorcycle, boat, etc.), includes program components that are designed for a one year timeframe, although credit scores may be improved in less time, or the timeframe can be extended as needed. The components include an education component, a proactive component, a monitoring component, and a measuring/results component.

### CROSS REFERENCES TO RELATED APPLICATIONS

Not applicable.

### BACKGROUND

1. Field of Invention

The present invention relates to increasing the credit score of a consumer, subsequently assisting the consumer in securing mortgage financing, or other types of loan financing, in the residential and commercial fields.

2. State of the Art

Prior to the development of credit history scoring models, individuals who applied for mortgage loans were approved or denied based on specific events related to their credit history. These events included, but were not limited to: the number of accounts they had open; the balances on their accounts; the type of accounts; the number of on-time payments; the number of late payments, and the degree to which those payments were late; the amount of time which had passed since the occurrence of late payments; the number of new accounts; the number of credit inquiries; and bankruptcy, to name a few. These events were reviewed by human underwriters to see if the required guidelines were met, and the loans were approved or denied based on the underwriter's review and discretion.

With the development of credit scoring models, many loan programs began to require a specific minimum credit score in order to be approved. The credit scoring models also allowed the development of automated underwriting systems which make the approval process more consistent, more manageable and more efficient. Currently, the credit scores from the 3 primary credit bureaus, Equifax, Trans Union, and Experian, are a key component in approving a mortgage loan through any and all automated systems. Because of this automation, it is critical to have a score that is high enough, and contains the right elements, for the system to approve the loan.

Mortgage loan requirements began tightening in early 2007 due to the high default rates associated with primarily subprime loan products. These loans were provided to many customers with credit scores in the 580-620 range, that typically could not qualify for traditional conventional loans. In addition, the sub-prime lenders offered non-typical, “outside the box” loan programs such as 100% financing, “stated income” loans, and other alternative, non-traditional forms of documentation, which allowed many people to qualify who would have been turned down under the traditional guidelines.

Unfortunately, while the sub-prime loan programs provided a product to meet the need of many home buyers, they also were misused by some lenders. The fall of the subprime lenders has left a large group of people who have the job, income, and desire to own a home, but are unable to qualify due to their credit scores. Additionally, the minimum credit score requirements for almost all loan programs have increased making it more difficult for every buyer to qualify. Loan rates are now tiered, based on credit scores, so that only the buyers with very high scores are eligible for the lowest possible rates. Thus, it is very important to have a high credit score, but most consumers lack an actual understanding of how credit scores are calculated, and how one might increase their credit score.

The background art is characterized by U.S. Pat. Nos. 7,280,980; 7,310,618; 7,249,076; 7,143,063; 7,076,462; 7,295,999; and 7,139,734; and U.S. Patent Applications 2007/0288338; 2007/0233591; 2003/0163435; 2007/0112668; 2007/0265958; 2007/0276750; 2007/0016517; 2007/0156552; and 2007/0150409; the disclosures of which patents and patent application are incorporated by reference as if fully set forth herein.

Non-patent background art is characterized on the following Internet pages: www.ftc.gov/bcp/edu/pubs/consumer/credit/cre03.shtm; www.homebuying.about.com/cs/yourcreditrating/a/improve_score.htm; www.lexingtonlaw.com/; www.nu-credit.net/lenders.asp; www.creditdoctorsoftware.com/pro-compare.htm; and turbocreditsolutions.com.

### SUMMARY OF THE INVENTION

An embodiment of the present invention provides for increasing the credit score of a consumer, which subsequently assists the consumer in securing mortgage financing, or any other type of loan financing. A method for increasing credit scores includes the following components: an education component, a proactive component, a monitoring component, and a measuring/results component, such that when put into action by a consumer, that consumer's credit scores will increase.

### BRIEF DESCRIPTION OF THE DRAWINGS

FIG. 1 shows a flowchart of an exemplary embodiment of the invention as presented in the invention's education component, such as at an informational seminar.

FIG. 2 shows the various components of the present invention.

FIGS. 3A, 3B, 3C, and 3D describe the subparts of the education component.

FIG. 4 describes the subparts of the proactive component.

FIG. 5 describes the subparts of the monitoring component.

FIG. 6 describes the subparts of the measuring/results component.

FIGS. 7A, 7B, 7C, and 7D describe an actual example of the present invention.

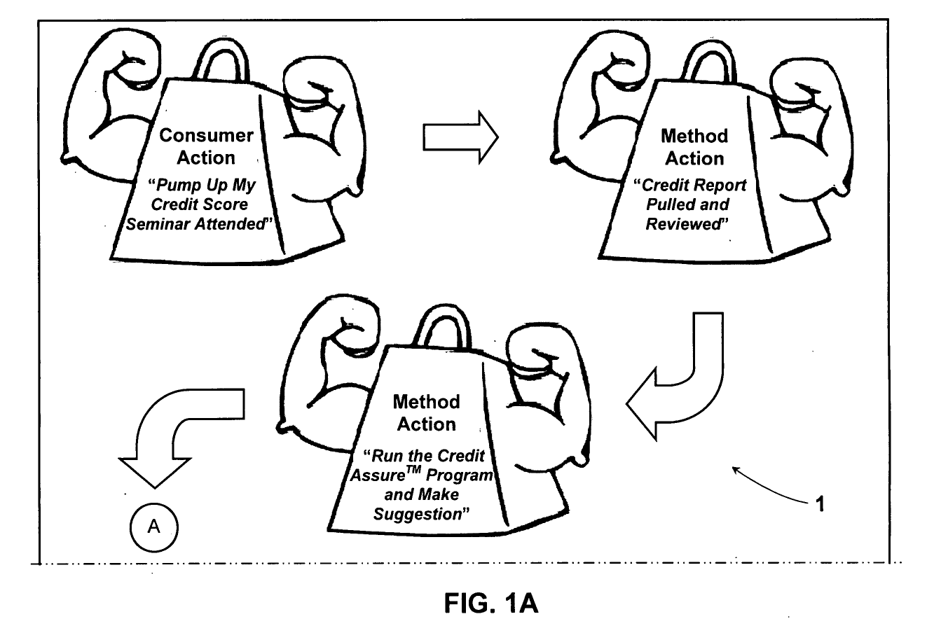

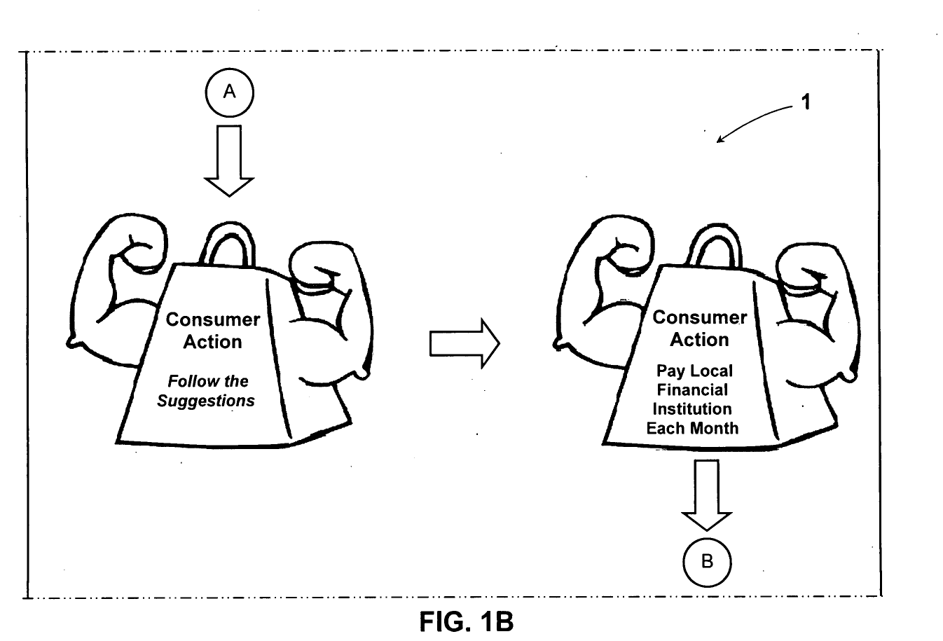

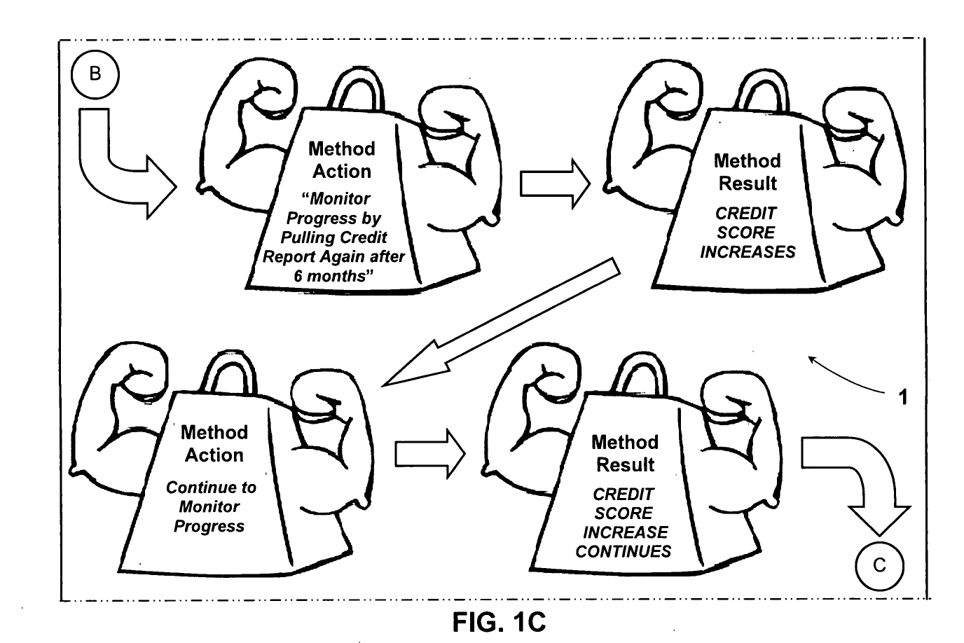

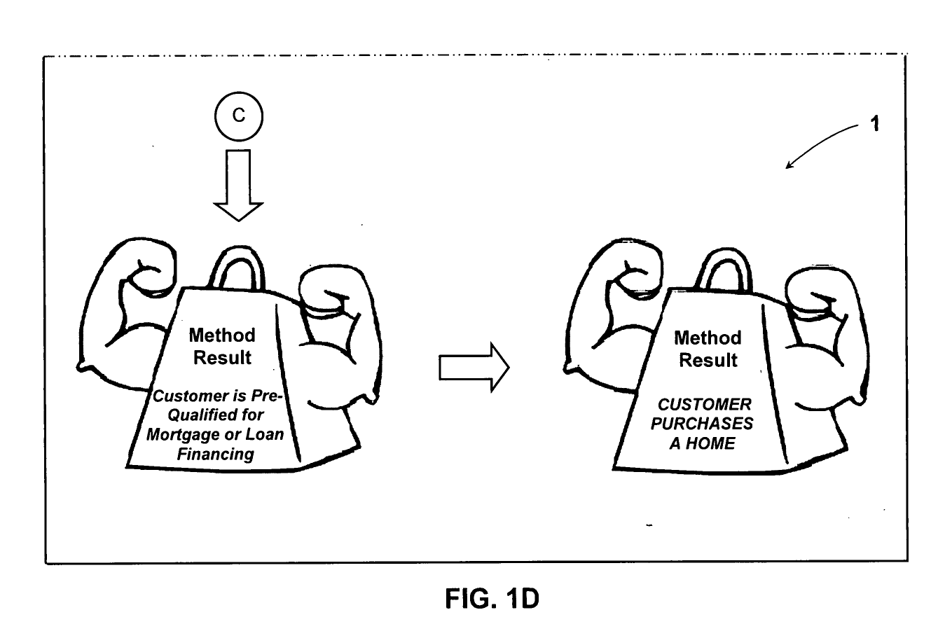

### DETAILED DESCRIPTION—ONE EMBODIMENT—FIGS. 1-6

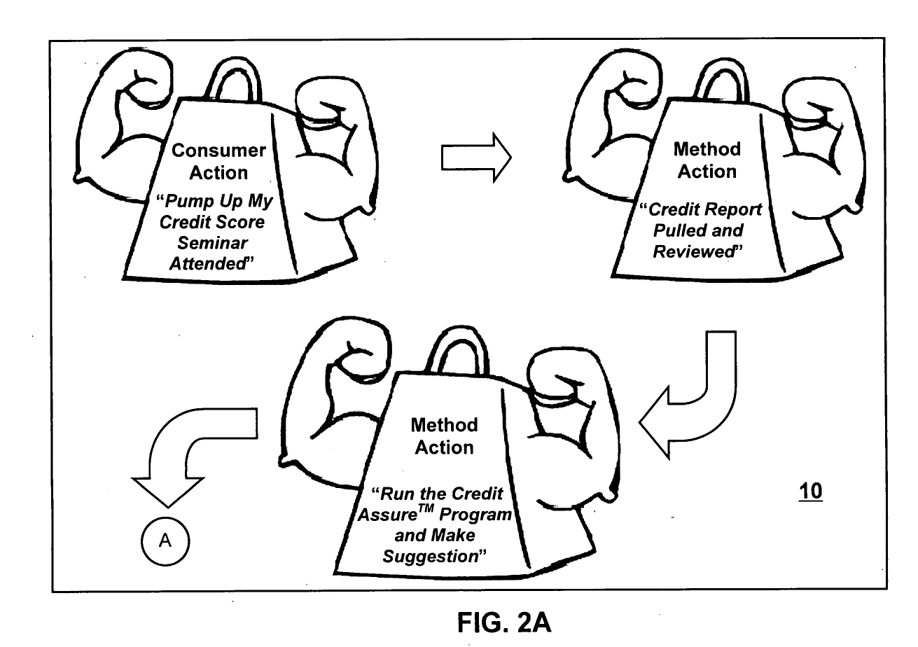

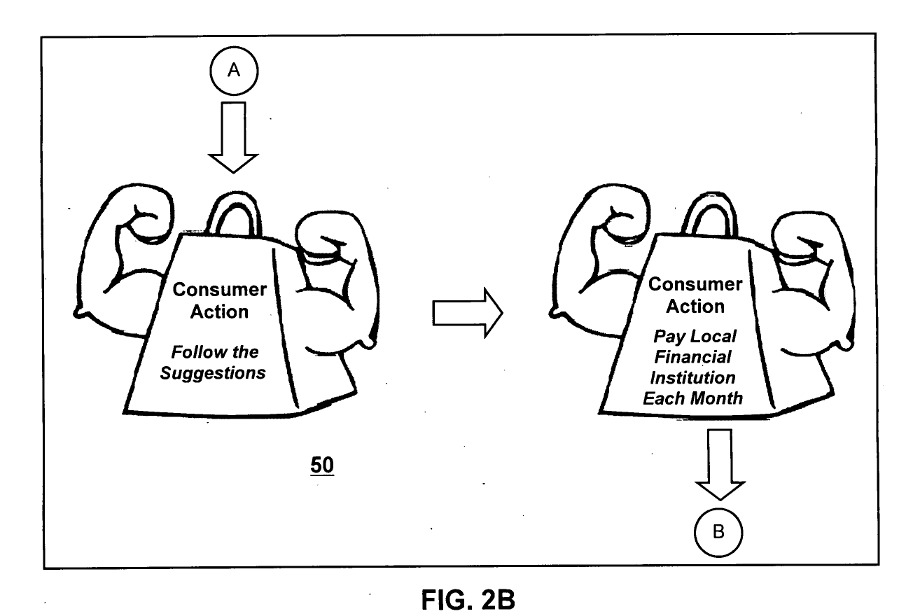

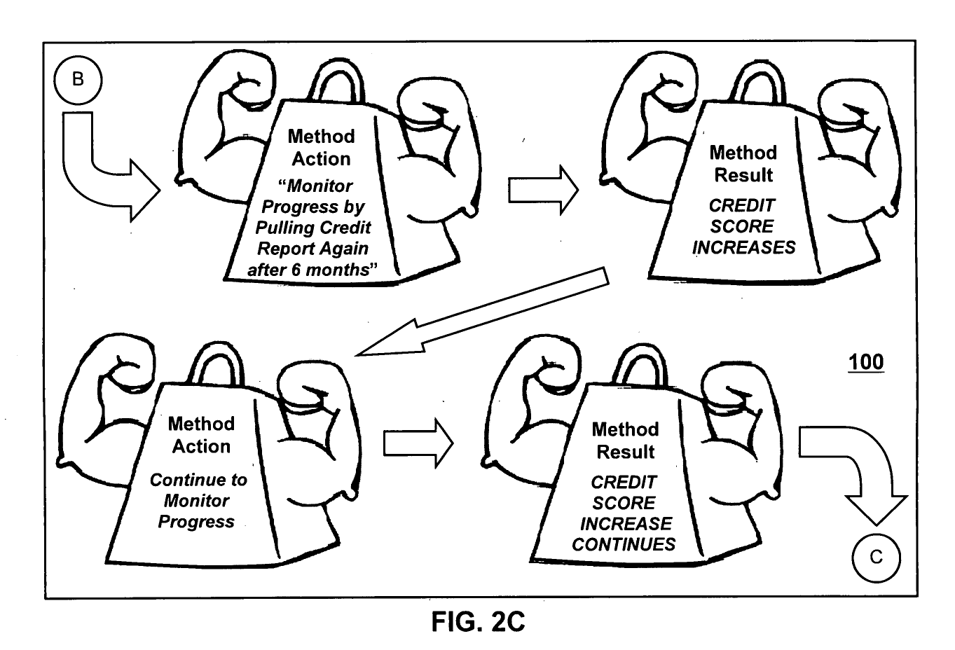

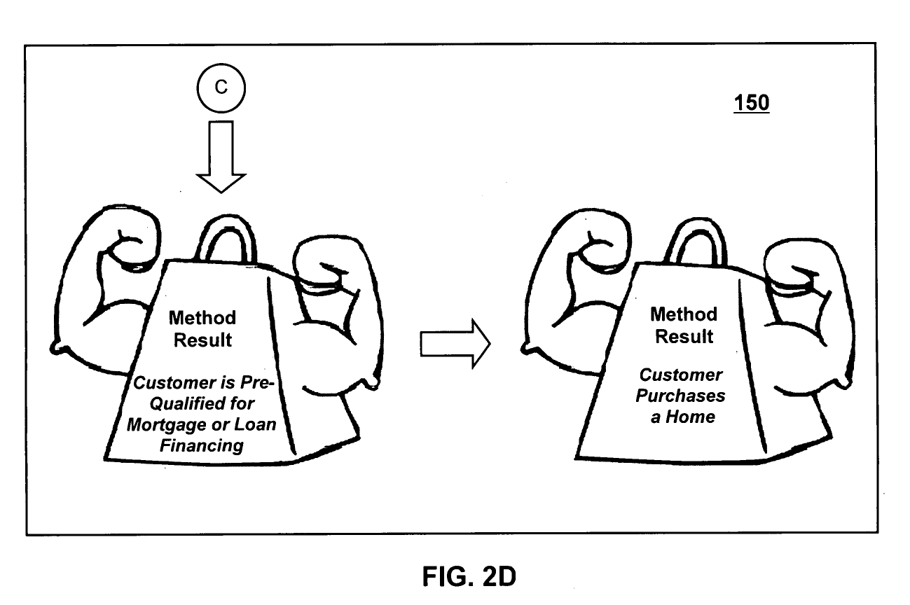

FIG. 1 illustrates a comprehensive Method or Program 1 for increasing a consumer's credit scores as presented in an informational seminar, on a website, or in an informational brochure, to name a few. FIG. 2 illustrates the subcomponents of comprehensive Method or Program 1, including an educational component 10, a proactive component 50, a monitoring component 100, and a measuring/results component 150.

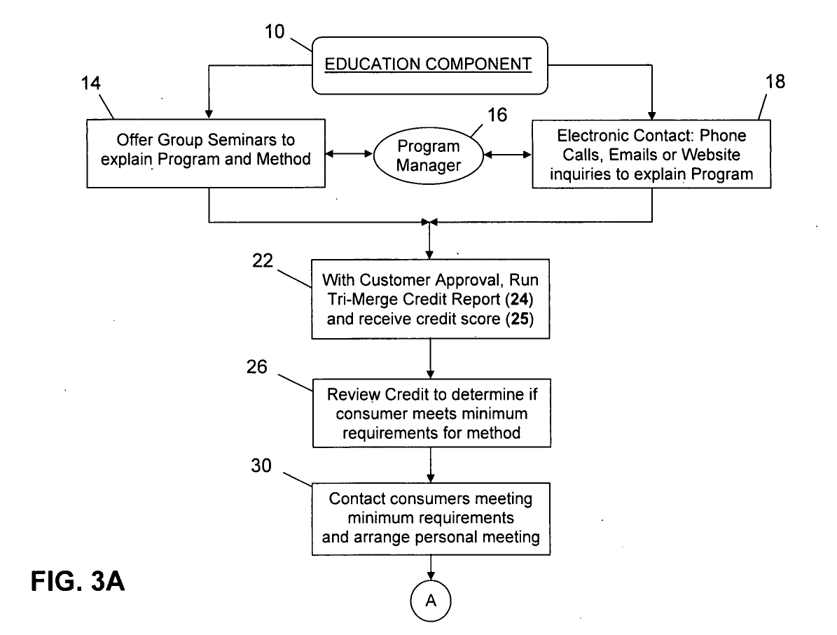

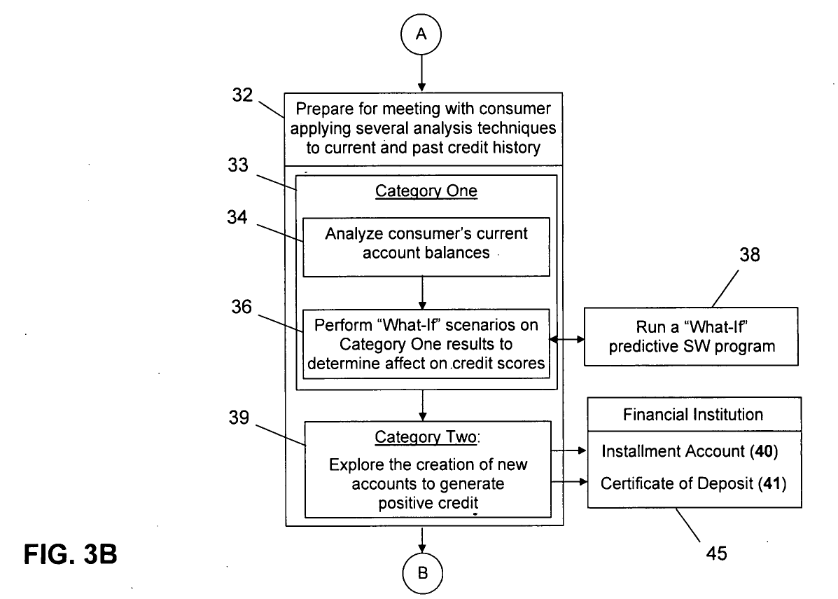

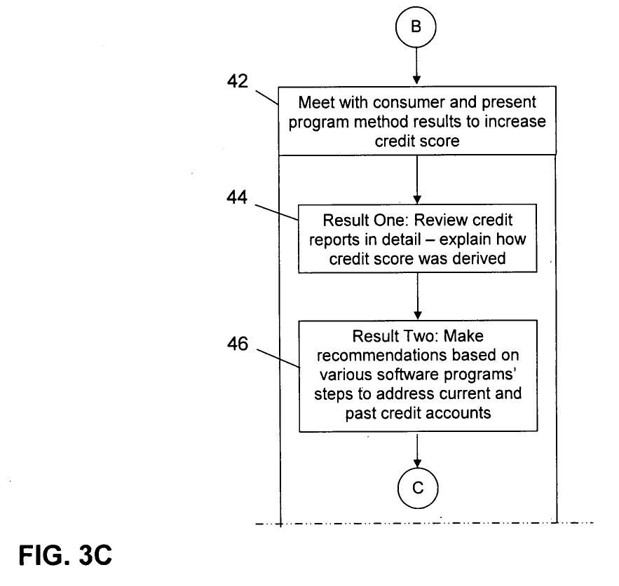

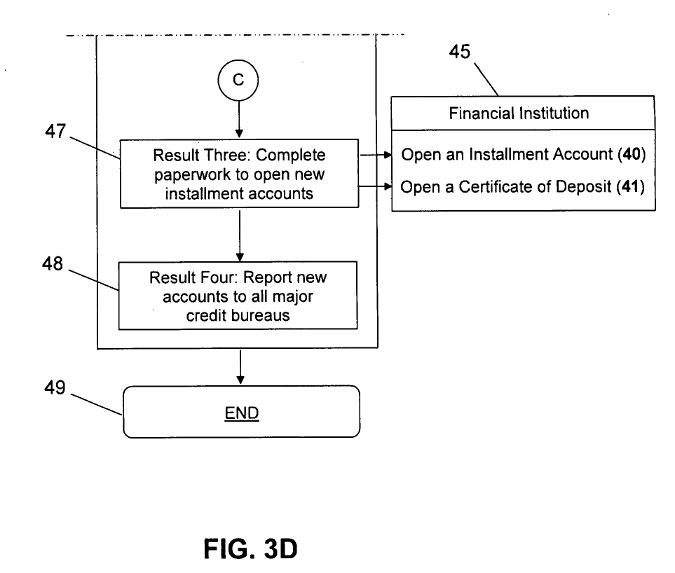

From FIG. 3A, the first step a consumer (or customer) will make to take advantage of Program 1 to increase their credit score 25 is to understand the background and processes of Program 1 through educational component 10. This is accomplished by attending an informational seminar 14, or electronically contacting an authorized organization 18 offering comprehensive Program 1 via electronic means such as: telephone; E-mail; or through an Internet website link to gain further information. In either approach a program manager 16 explains Program 1, compares it to other programs in the marketplace, and sets expectations of the results.

Once the consumer has spoken with program manager 16, is interested in pursuing Program 1, and gives program manager 16 permission to run a credit check or report, program manager 16 will implement a “generate credit report” procedure 22, a mortgage industry standard that provides a comprehensive, detailed Tri-Merge credit information report 24, which is a computer-generated set of data records and data attributes, calculated at the time of the request based on the consumer's credit history as reported by all three current primary national credit bureaus—Equifax (Equifax Credit Information Services, Inc, P.O. Box 740241, Atlanta, Ga. 30374); Trans Union (TransUnion, P.O. Box 6790, Fullerton, Calif. 92834), and Experian (Experian, P.O. Box 5001, Costa Mesa, Calif. 92628-5001). This ensures program manger 16 has the most accurate and complete reports available as well as the most representative credit scores 25. At this point, there is no cost or obligation to the customer for running these reports.

The next step in educational component 10 is a “pre-qualification” procedure 26 where the consumer's credit report 24 is reviewed to determine if the customer is a good candidate for Program 1. A good candidate is someone that has an excellent chance of raising their credit score 25 into the 650 range within a certain time period (six months is the typical time period but that can vary based on the consumer's credit background and willingness to follow Program 1 steps). Most credit scoring systems are different and unique because they are based on a creditor's individual experiences with customers, but in general credit scores have a range between 300 and 850: 700-850—Excellent or Very Good Credit; 680-699—Good Credit; 620-679—Okay or Average Credit; 580-619—Low Credit; 500-580—Poor Credit; 300-499—Bad Credit. Excellent candidates would be those with previous bankruptcy or foreclosure that have not reestablished their credit; those with very limited credit; those with old derogatory credit; those with multiple account balances; and those with no credit, to name a few.

Those consumers with a credit score below 500, and/or with an event that cannot be overcome with a Program 1 step, are typically removed from consideration. Examples of such events include: an active bankruptcy; a pending or very recent foreclosure; court judgments that are too large to be paid within a reasonable amount of time; repossessions that cannot be paid; delinquent child support; and tax liens, to name a few. Program 1 may still be able to help these customers raise their credit scores 25 but it cannot guarantee their ability to qualify for a home loan, or another type of loan, unless these events are dealt with properly.

After pre-qualification 26 is complete, Program manager 16 performs a “contact consumer” procedure 30, wherein those consumers meeting the minimum requirements are contacted, initial fees are discussed, and a meeting time and place are established.

If the consumer agrees to participate in Program 1, then as shown in FIG. 3B, program manager 16 performs a “preparation” procedure 32, prior to meeting with the customer. Preparation procedure 32 consists of implementing several analysis techniques, which fall under different categories in this procedure. A set of analysis techniques is employed in a Category One 33. First, Program 1, in an “analyze accounts” procedure 34, examines the customer's current account balances and makes recommendations of specific corrective actions the consumer can take to improve their credit scores 25. The recommendations may include paying off or paying down balances. By doing this, the customer reduces, or lowers, their ratio of balances-to-credit limits and becomes a lower risk. A low ratio of balances-to-credit limits ratio indicates the consumer uses their available credit wisely, which is important to lenders, and plays a significant part in credit risk scoring. For example, in general, it is better to leave credit card accounts open if you have zero balances than it is to close them, especially if there is no negative activity associated with the account. This is because for each zero balance credit card account that is closed, the ratio of balances-to-credit limits ratio goes up, and it suddenly appears one may be overusing their credit. Unused credit results in a lower ratio of balances-to-credit limits ratio. These specific recommendations are made and the potential score increases are predicted in the next step, based on the actions taken by the customer.

A second analysis technique under Category One 33 then performs a set of “what-if” predictive simulations 36 to determine the effect on the consumer's credit score 25. As one example, a software program 38, such as Credit Assure™ or CreditXpert® What-if Simulator™ from CreditXpert® (available from Credit Technologies, Inc., 50481 W. Pontiac Trail, Wixom, Mich. USA 48393-2028), although other similar predictive software or simulation software programs or methods will suffice, initially search for inaccurate information (e.g., incorrect, outdated, or missing data), and provide this information, such that when corrected, may increase credit scores 25. Software program 38 also seeks the best combination of pay downs on accounts, balance transfers between accounts, and other activities through credit management techniques to increase credit scores 25. For example, what if a 2 year old medical collection is paid off? Will this increase credit score 25? Program 1 inputs this data into “what-if” simulation program 38 and examines the results. If credit score 25 increases, it may be wise to pay down that debt or spend more effort on that debt to resolve the collection issue. If it will have little or no impact on credit score 25, it may be better to spend time and financial resources in another way.

As also shown in FIG. 3B, an additional analysis technique under Category Two 39 explores the novel technique of opening a new installment loan account 40, or multiple accounts, to generate positive credit, that in turn can raise consumer credit score 25. In most cases customers are hesitant to apply for new credit because they have had problems in the past. However, the best measure of their credit worthiness is how they perform now. If they manage new installment account(s) 40 correctly, in addition to addressing current and old accounts (predictive software 38), then credit scores 25 will improve. For Category Two 39, Program 1 further uses a novel method that reduces the financial risk to a financial institution 45 while simultaneously helping the consumer. New installment loan accounts 40 are opened at local financial institution 45 simultaneously with a Certificate of Deposit (CD) 41, although more than one CD 41 can be opened. Certificate of Deposits 41 are similar to savings accounts in that they are insured and thus virtually risk-free (CDs 41 are insured by the Federal Deposit Insurance Corporation (FDIC) for banks or by the National Credit Union Administration (NCUA) for credit unions). They differ from savings accounts in that the CD 41 has a specific, fixed term (often three months, six months, or one to five years), and, usually, a fixed interest rate. It is intended that the CD 41 be held until maturity, at which time the money may be withdrawn together with the accrued interest. In this method fully-funded CD 41 becomes the collateral for new installment loan(s) 40, thus removing the financial risk to the financial institution 45. A plurality of funds 52 from installment loan(s) 40, which is the same amount as that used to open CDs 41, are dispersed to the consumer, who then uses funds 52, or other funds, to make on-time, periodic payments, preferably by an auto withdrawal method 56, to financial institution 45 in order to pay down installment loan(s) 40. As an additional incentive offered by Program 1, once the loans are paid back, CD 41 can be liquidated or can remain on deposit as an investment and continue to earn interest. As one example, Program 1 recommends the consumer open a $1,000 CD 41 with financial institution 45. At the same time, Program 1 recommends the consumer open two $500 installment loans 40 with the same financial institution 45. The consumer then pays back installment loans 40 with dispersed funds 52 over the time period of the CD 41 term. Note that more than one CD 41 may be opened, or fewer or more than two installment loans 40 may be opened, that is, there is not a limitation on the number of loans 40 or CDs 41 necessary to implement Category Two method 39.

As shown in FIG. 3C, program manager 16 then performs a “meet with the consumer” procedure 42 to present Program 1 results. In a “Result One” procedure 44, program manager 16 explains the consumer's credit reports 24 in detail and how credit score 25 was derived. This involves going through Tri-Merge Credit Report 24 and emphasizing how credit score 25 was affected by certain components in credit report 24. In a “Result Two” procedure 46, program manager 16 describes ways the consumer's credit score 25 can be improved, and makes recommendations, based on predictive software program 38 results, of steps they should take to address their current and past credit accounts. For example, the consumer, with or without the aid of program manager 16, can pay down accounts that heavily affect credit score 25, remove incorrect data within Tri-Merge Credit Report 24, or dispute items shown in Tri-Merge Credit Report 24, to name a few. Some of Program 1 recommendations may require that the customer provide documentation regarding a particular account. As the documentation is provided, program manager 16 assists in getting the credit bureaus updated with the most accurate information in a very short time (termed rapid rescoring).

In FIG. 3D, a “Result Three” procedure 47 is employed where program manager 16 explains the concept of opening installment account(s) 40 and Certificate of Deposit account 41, both in the consumer's name, in order to build new credit references. Program manager 16 then assists the consumer in opening account(s) 40 and CD 41 at financial institution 45, followed by directly updating the credit bureaus in order to begin building all three credit scores immediately in a “Report New Accounts” procedure 48. Program manager 16 then sets the consumer's expectations based on Program 1 historic results as far as how much and when their score will increase.

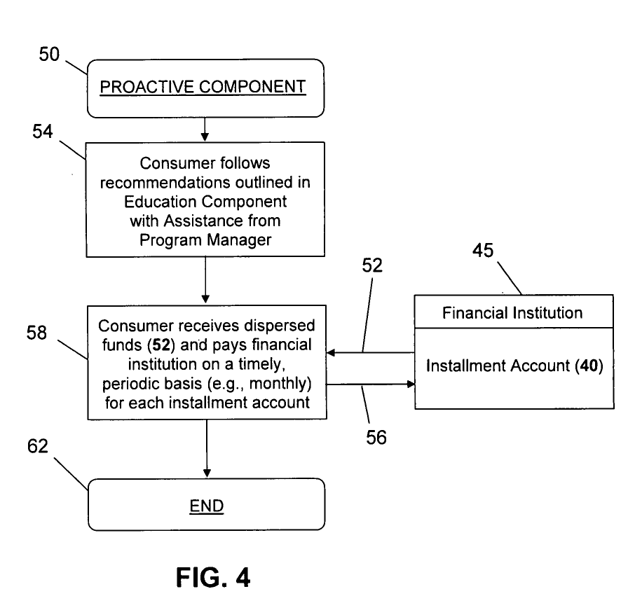

As shown in FIG. 4, the next step a consumer will make to take advantage of Program 1 to increase their credit score 25 is to implement the suggestions and recommendations provided by Program 1 through proactive component 50, with direct assistance from program manager 16. After program manger 16 meets with the customer and explains credit history 24, and the possible ways to enhance credit score 25 through credit history 24 changes, the consumer must follow these credit history 24 changes, as outlined in a Step 54, with direct assistance from program manager 16). Program manger 16 also ensures the consumer pays financial institution 45, preferably with auto withdrawal method 56, on a timely, periodic schedule, e.g., monthly, for loan(s) 40, as outlined in a Step 58. At this point, after all “Result” services, 44, 46, 47, and 48, have been performed, a nominal fee is requested from the consumer to cover the cost of running credit history report 24; evaluating and explaining such reports 24 (Result One procedure 44); running predictive simulations 38 (software license charges); making recommendations (Result Two procedure 46); initial counseling; and assistance in opening installment loans 40; CD 41 accounts (“Result Three” procedure 47); and reporting new accounts to all credit bureaus (“Result Four” procedure 48). There are no more fees for Program 1 after this point.

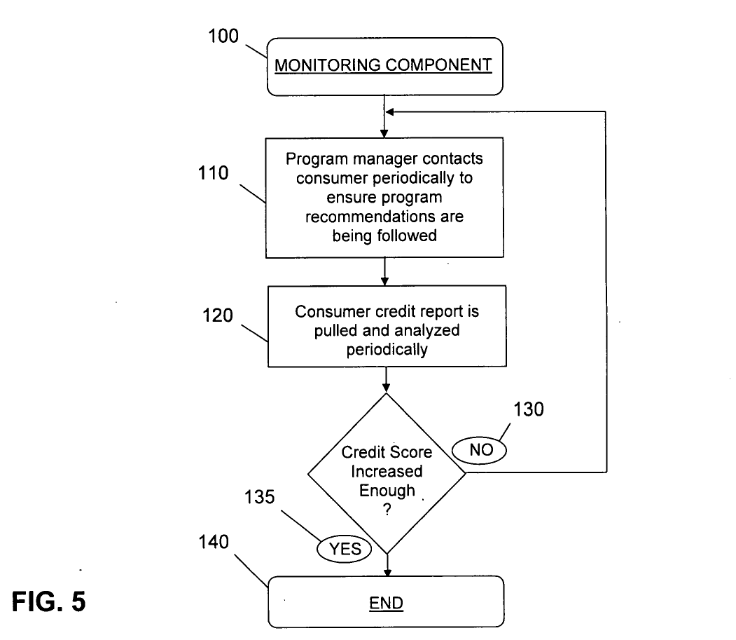

In FIG. 5, program manager 16 then assists the consumer in following proactive procedure 50 throughout the Program 1 term until the consumer's credit score 25 is adequate to obtain mortgage or other loan financing. The first step in monitoring component 100 is a “periodic contact” procedure 110 where program manager 16 periodically contacts the consumer to make sure the consumer is following Program 1 guidelines and recommendations. This is a novel and important aspect of the present invention as the consumer, who typically is uncomfortable with credit issues and financial transactions, knows they have on-going support and guidance from program manager 16 through the entirety of Process 1. This greatly increases the likelihood that credit score 25 will increase sufficiently to place the consumer back in good credit standing. During monitoring component 100, program manager 16 also periodically retrieves an additional Tri-Merge credit information report 24 (in a step 120). Credit report 24 is reviewed and a determination is made as to whether credit score 25 has improved enough to place the consumer back in good credit standing such that the customer can qualify for mortgage financing, or some other type of loan. If credit score 25 has not risen sufficiently, monitoring phase 100 continues (at a decision point 130) until credit score 25 rises sufficiently. In this cycle, once credit score 25 rises sufficiently, typically to the Average or Good credit level, at a decision point 135, program manager 16 informs the consumer of the positive results, and this phase of Program 1 is complete.

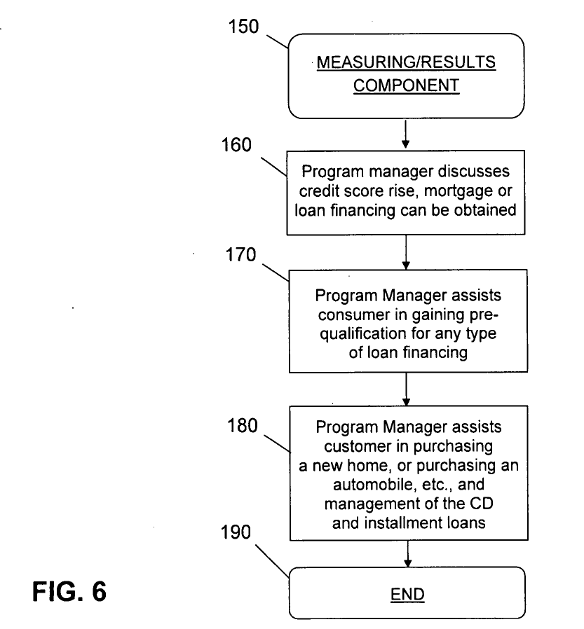

As shown in FIG. 6, a “measuring/result” component 150 occurs next. In this phase program manager 16 meets with the consumer in a “discuss results” procedure 160 and discusses the post-results of Program 1 with respect to increased credit score 25 of the consumer's credit rating. Program manager 16 further informs the consumer of the post-opportunities this increase affords them with respect to many types of loan financing, included, but not limited to, mortgage financing, business financing, and general loan financing (e.g., automobile, motorcycle, boat, etc.). If the consumer desires, in an “assist consumer” procedure 170, program manager 16 will assist them in working with a realtor and/or mortgage originator, or some other type of loan officer, so that the consumer may purchase a home, some other type of asset, or open some other type of loan (in a step 180). Program manager 16 may also advise/assist the consumer regarding CD 41 when it comes to full term (e.g., close CD 41 and remove the principal plus interest earned, or leave CD 41 open and allow it to gain more interest), and how to close out installment loans 40, if desired.

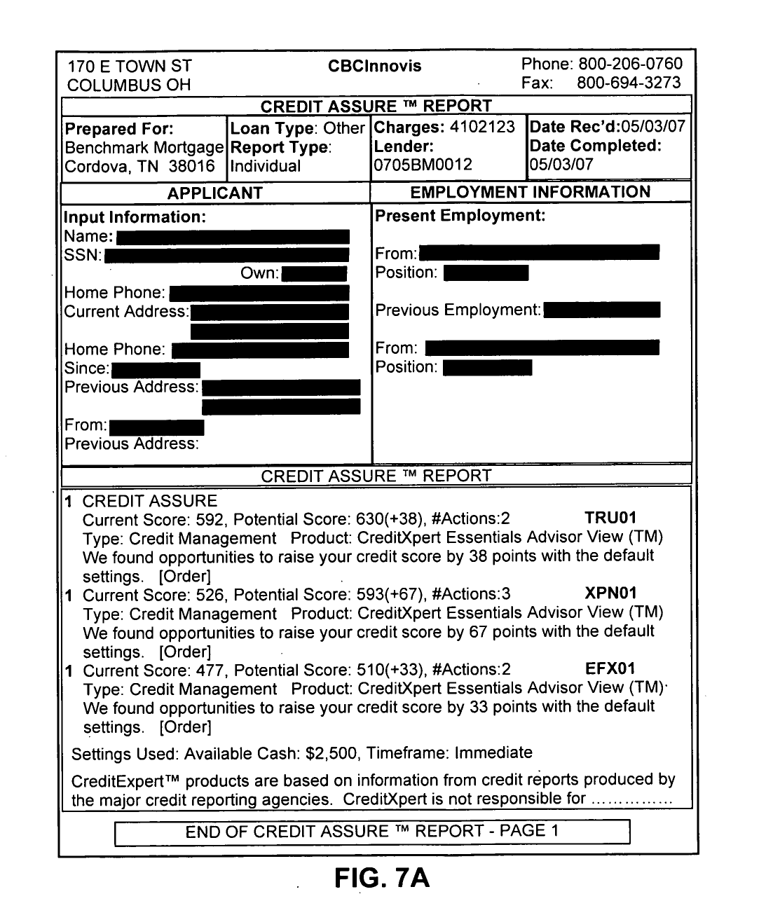

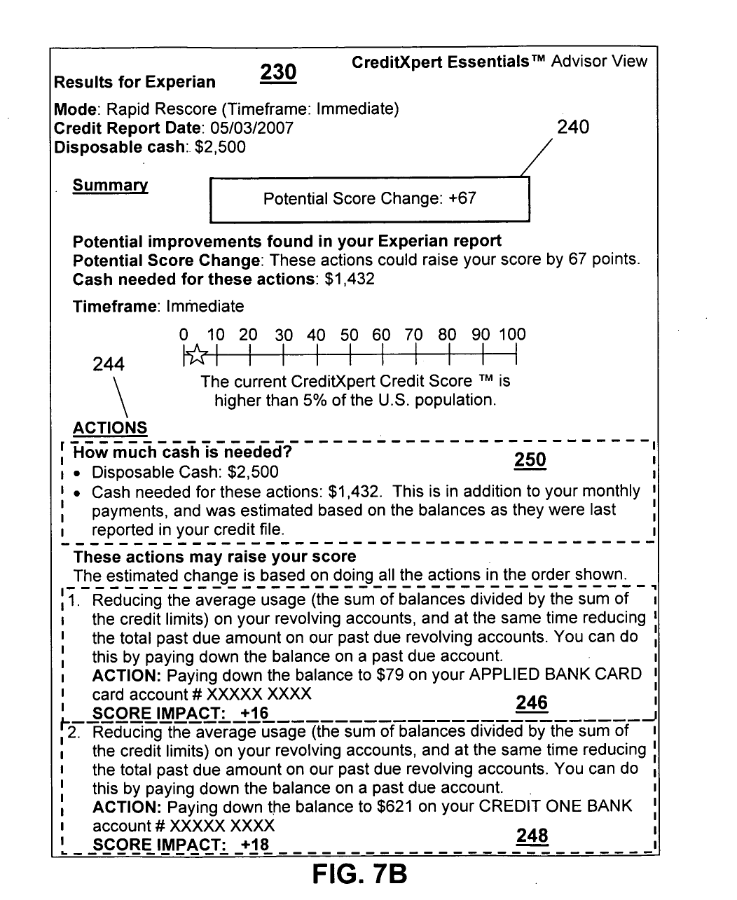

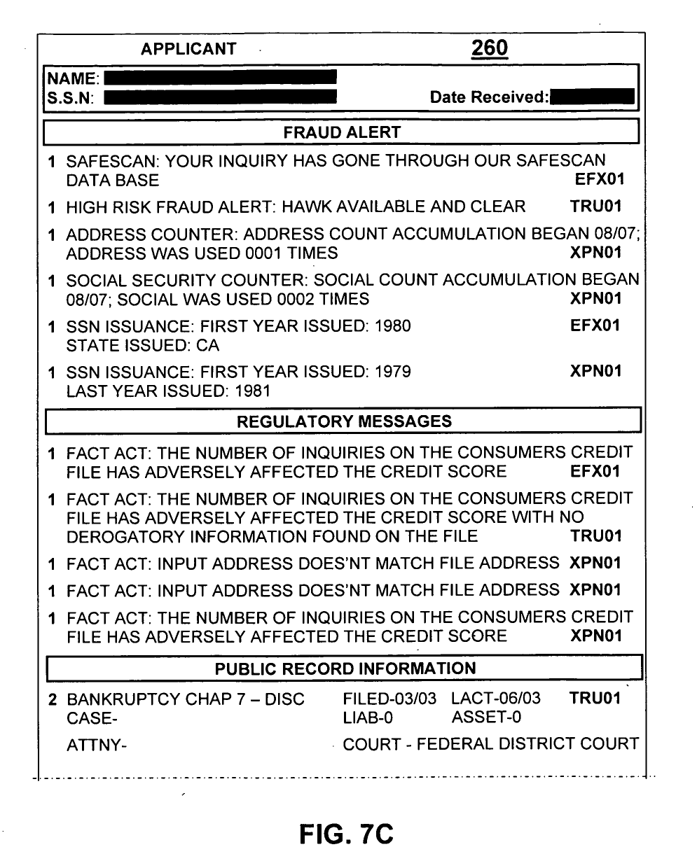

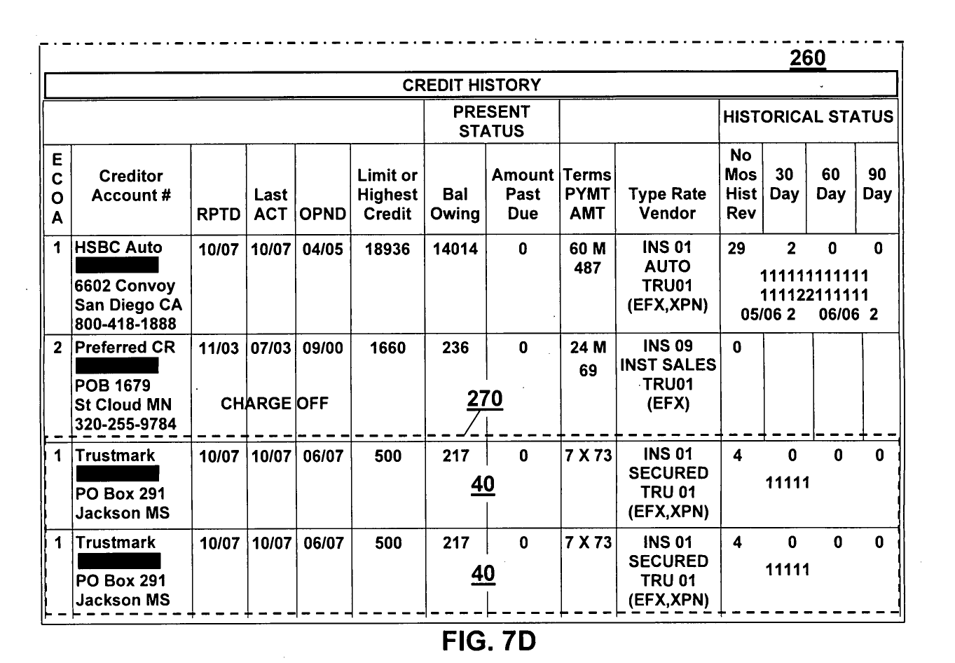

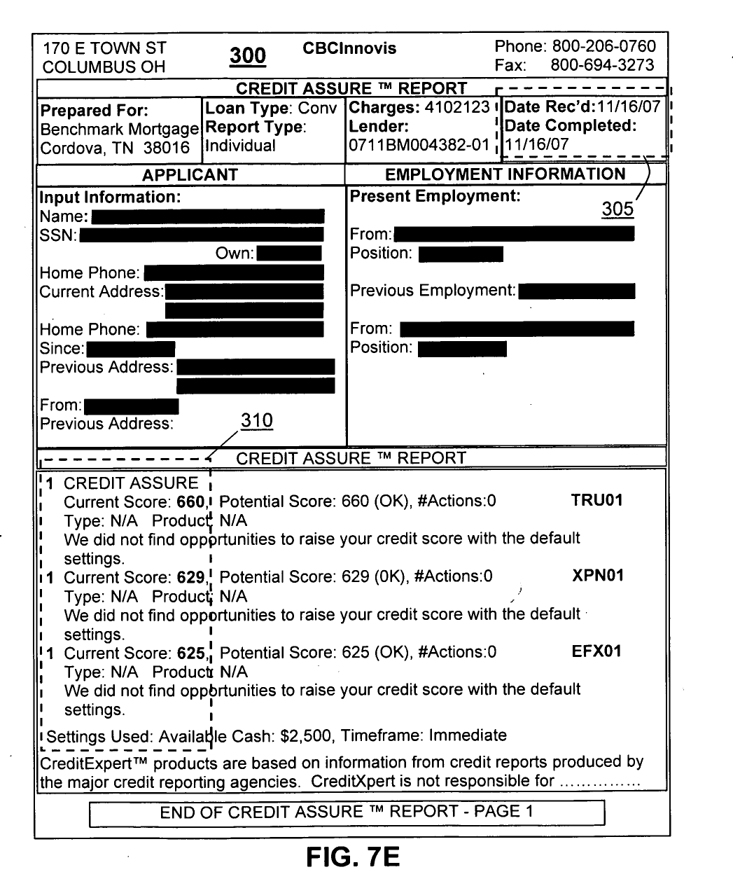

### DETAILED DESCRIPTION—WORKING EXAMPLE—FIG. 7A-7D

FIGS. 7A-7D describe a working example of how Method or Program 1 functions. For this example a consumer has attended a Program 1 seminar and has agreed to enroll in Program 1. The consumer has $2,500 disposable cash to use in Program 1, and the start date of Program 1 is May 3, 2007. In this example, Credit Assure™ simulation software 38 has been used, although other predictive or simulation programs can be used. In FIG. 7A, Tri-Credit Report 24 and a representative Credit Assure report 200 have been implemented (via “what-if” simulation program 38) through an authorized representative mortgage company 202 for a consumer 204 (note that although this is an actual report, the consumer name has been removed to protect confidentiality). A set of initial or current credit scores 210 are shown to the left of the report (scores of 592; 526; and 477, for an average of 531). A set of potential scores 220 are shown to the right of the report (scores of 630; 593; and 510, for an average of 578), which are based on credit management techniques (such as correcting credit history, implementing account pay downs, performing balance transfers, etc.). Program manager 16 explains these results to the consumer.

In FIG. 7B, an Advisor View 230 of Credit Assure report 200 shows a potential score increase 240 for the Experian credit agency based on implementing the credit management techniques mentioned just above. Note that only the Experian data is shown for this example, although all data from the credit bureaus will be retrieved and analyzed. In this example credit score 25 can increase by +67 points by taking a set of certain actions 244. In FIG. 7B only two actions are shown: (1) pay down the balance on a certain past-due Applied Card Bank account to $79, which results in an increase of +16 points, as shown in a block 246; and (2) pay down the balance on a certain past-due Bank account to $621, which results in an increase of +18 points, as shown in a block 248. These two actions will raise credit score 25 by 34 points (16+18=34 points). Note there are other actions to be taken to further raise credit score 25 to potential score increase 240 (+67 points), but these are not shown in this example, as these two actions shown demonstrate the underlying inventive method. Overall, under Category One 34, Program 1 recommends spending $1,432, as shown in a block 250, to increase credit score 25 by +67 points. Program manager 16 directly assists the consumer in making these payments and addressing any other credit report 24 issues that exist. The consumer now has $1,068 to apply to Category Two 39 of the Program.

Program 1 then recommends opening two $500 installment loans 40 and a $1,000 CD 41 to secure (collateralize) those loans. Program manager 16 directly assists the consumer in opening loans 40 and CD 41, and in making on-time, periodic (e.g., monthly) payments on the two installment loans 40. Program manager 16 makes periodic contact with the consumer to support Program 1 steps. As shown in FIG. 7C, after 5 months a credit history 260 is retrieved and examined (note all account numbers have been removed to protect confidentiality). An additional credit history report 260 shows that all monthly payments on the two installment loans 40 have been made on time, as shown in a block 270. As shown in FIG. 7D, on Nov. 16, 2007, as shown in a block 305, approximately six months after Program 1 is implemented, and recommendations followed by the consumer, an additional Credit Assure™ report 300 is run. A new set of results 310 show that credit scores 25 have been successfully raised by Program 1 by an average of +107 points to 638 (average of 660; 629; and 625). Although Program 1 has been in effect for only 6 months, the consumer is now in good credit standing and can apply for a home mortgage or a variety of other types of loans. If Program 1 is allowed to continue through the 1-year CD 41 time period, credit scores 25 will continue to increase ensuring the consumer will get a better interest rate on a variety of loans.

From the foregoing, it is apparent that the program method described above not only provides for the reliable accomplishment of the purpose of the invention, but does so in a particularly straightforward and reliable manner. It is recognized, of course, that those skilled in the art may make various modifications or additions to the exemplary embodiments chosen to illustrate the invention without departing from the spirit and scope of the present contribution to the art. Accordingly, it is to be understood that the protection sought and to be afforded hereby should be deemed to extend to the subject matter claimed and all equivalents thereof within the scope of the invention.

What is claimed is:

1. A novel method for increasing a plurality of credit scores of a consumer, said method comprising:
educating said consumer on a plurality of recommendations generated by said novel method;
assisting said consumer in proactively implementing said recommendations;
monitoring proactive actions of said consumer while said consumer implements said recommendations; and
measuring results of said implemented recommendations.

2. The method of claim 1, wherein said educating said consumer further comprises having said consumer attend an informational seminar.

3. The method of claim 1, wherein said educating said consumer further comprises having said consumer electronically contact an organization authorized to implement said novel method.

4. The method of claim 1, wherein said educating said consumer further comprises requesting from said consumer permission to retrieve a credit report pertaining to said consumer.

5. The method of claim 4, wherein said retrieving said credit report further comprises compiling data records and data attributes from a plurality of credit reporting agencies.

6. The method of claim 5, wherein said data records and data attributes are analyzed to determine if said consumer is a candidate for said novel method for increasing said plurality of credit scores.

7. The method of claim 5, wherein said data records and data attributes are analyzed to recommend at least one possible corrective action to increase said plurality of credit scores.

8. The method of claim 7, wherein said at least one possible corrective action is input to a simulation program to determine the effects of said corrective action on said plurality of credit scores.

9. The method of claim 1, wherein said educating said consumer further comprises recommending opening a plurality of financial accounts, said accounts comprising at least one installment loan account and at least one certificate of deposit account, both accounts registered in said consumer's name.

10. The method of claim 9, wherein said at least one certificate of deposit account serves as collateral for said at least one of installment loan account.

11. The method of claim 1, wherein said assisting said consumer further comprises meeting with said consumer to provide details of said recommendations, said recommendations comprising taking corrective actions on a retrieved credit report of said consumer.

12. The method of claim 11, wherein said providing details to said consumer further comprises helping said consumer in taking proactive actions to correct issues in said consumer's retrieved credit report.

13. The method of claim 1, wherein said assisting said consumer further comprises meeting with said consumer to provide details of said recommendations, said recommendations comprising opening a plurality of financial accounts, said accounts comprising at least one installment loan account and at least one certificate of deposit account, both accounts registered in said consumer's name.

14. The method of claim 13, wherein said providing details to said consumer further comprises helping said consumer open said plurality of financial accounts in said consumer's name.

15. The method of claim 13, wherein said at least one installment loan account disperses funds to said consumer, said funds being used to pay down said at least one installment loan account.

16. The method of claim 13, wherein said providing details to said consumer further comprises helping said consumer establish an automatic payment program for making on-time, periodic payments to pay down said at least one installment loan account.

17. The method of claim 13, wherein said providing details to said consumer further comprises reporting said plurality of new financial accounts to all credit bureaus.

18. The method of claim 1, wherein said monitoring said consumer's proactive actions further comprises maintaining periodic contact with said consumer.

19. The method of claim 1, wherein said monitoring said consumer's proactive actions further comprises retrieving at least one additional credit report.

20. The method of claim 19, wherein said at least one additional credit report is analyzed to determine if said consumer's plurality of credit scores have increased sufficiently to place said consumer in at least average credit standing.

21. The method of claim 1, wherein said measuring of said implemented recommendations further comprises meeting with said consumer to discuss results of said implemented recommendations.

22. The method of claim 21, wherein said meeting with said consumer further comprises assisting said consumer with post-method opportunities, said opportunities comprising obtaining pre-qualification for financing a plurality of loan types; obtaining said loans; managing of said at least one installment loan account; and managing of said at least one certificate of deposit account.

23. A novel method for increasing a plurality of credit scores of a consumer, said method comprising:
having said consumer contact an organization authorized to implement said novel method;
retrieving a credit report pertaining to said consumer, said credit report providing said plurality of credit scores;
deciding if said consumer can benefit from said novel method, based on said credit report;
analyzing said consumer's credit report to produce at least one corrective action, said action increasing at least one of said plurality of credit scores;
assisting said consumer in taking said corrective actions;
recommending said consumer open a plurality of financial accounts, said accounts comprising at least one installment loan account and at least one certificate of deposit account, said at least one certificate of deposit account serving as collateral for said at least one installment loan account;
helping said consumer open said at least one installment loan account and said at least one certificate of deposit account;
reporting said newly opened accounts to all credit bureaus;
assisting said consumer in establishing automatic payment program for making on-time, periodic payments to pay down said at least one installment loan account using funds disbursed from said at least one of said installment loans;
monitoring said consumer's progress by retrieving an additional credit report after a defined amount of time, said credit report analyzed for credit score increases; and
meeting with said consumer to aid said consumer in implementing credit score increase opportunities, said opportunities comprising obtaining pre-qualification for financing a plurality of loan types; obtaining said loans; managing of said at least one installment loan account; and managing of said at least one certificate of deposit account.
